(19) United States
(12) Patent Application Publication
(10) Pub. No.: US 2014/0376070 A1
(43) Pub. Date: Dec. 25, 2014

(54) Micro-electromechanical reflector and method for manufacturing a micro-electromechanical reflector

(71) Applicant: Jochen REINMUTH, Reutlingen (DE)

(72) Inventor: Jochen REINMUTH, Reutlingen (DE)

(73) Assignee: Robert Bosch GmbH, Stuttgart (DE)

(21) Appl. No.: 14/313,716

(22) Filed: Jun. 24, 2014

(30) Foreign Application Priority Data
Jun. 25, 2013 (DE) 10 2013 212 095.8

(51) Int. Cl. G02B 26/08

(52) U.S. Cl. CPC G02B 26/0833
USPC 359/221.2; 29/846

(57) ABSTRACT

A micro-electromechanical reflector includes an electrode substrate having first and second surfaces opposite to the first surface, on whose first surface a monocrystalline silicon layer is situated, a plurality of electrode recesses, which are introduced from the second surface into the electrode substrate, at least one torsion spring structure, which is implemented in the monocrystalline silicon layer above one of the electrode recesses, a carrier substrate, which is applied to the second surface of the electrode substrate, and a reflector surface situated on the monocrystalline silicon layer. At least one first electrode, movably mounted in the electrode substrate via the torsion spring structure, and at least one second electrode, mechanically fixedly anchored to the carrier substrate and the monocrystalline silicon layer, are formed by the electrode recesses. The electrode surfaces of the first and second electrodes are situated in parallel to one another and perpendicularly to the electrode substrate surfaces.

### RELATED APPLICATION INFORMATION

The present application claims priority to and the benefit of German patent application no. 10 2013 212 095.8, which was filed in Germany on Jun. 25, 2013, the disclosure of which is incorporated herein by reference.

### FIELD OF THE INVENTION

The present invention relates to a micro-electromechanical reflector and a method for manufacturing a micro-electromechanical reflector, in particular in the field of capacitively operated micro-electromechanical reflectors.

### BACKGROUND INFORMATION

Miniaturized mirrors are used for various applications, for example, for optical components in portable telecommunication devices. These mirrors—frequently also called micro-mirrors—may be manufactured from micro-electromechanical structures (MEMS, “micro-electromechanical systems”).

Such micro-mirrors may be based on the capacitive action principle, i.e., a voltage is applied to two electrode elements situated in a predetermined geometry in relation to one another. By varying the voltage, movements of the electrodes in relation to one another may be induced. One of the electrodes is generally fixed on a substrate, while another of the electrodes is freely movable with respect to the substrate at least with respect to one degree of freedom.

In the case of capacitive micro-mirrors, the micro-mirror is typically situated on a substrate and deflected out of the substrate plane via one or multiple torsion axes. The torsion may be excited via electrodes, which are situated vertically in relation to the substrate, spaced apart from one another, and underneath the micro-mirror. If a control voltage is applied between the electrodes, the electrostatic attraction or repulsion force between the electrodes results in tilting around the torsion axis, which is generally located on the substrate surface, so that the micro-mirror, which lies above it and is mechanically coupled to the tilted electrodes, tilts out of the substrate plane.

U.S. Pat. No. 7,079,299 B1 discusses an electrostatic comb structure in a silicon substrate, which is configured for the purpose of rotating a micro-mirror situated above it around a torsion axis. U.S. Pat. No. 6,694,504 B2 discusses a method for manufacturing a micro-mirror, whose torsional electrostatic drive structure has electrodes, which are vertically etched in a silicon substrate and are vertically offset in relation to one another.

Multiple etching and deposition processes are to be carried out over the entire substrate height in the manufacture of such micro-mirrors. This may result in restrictions in the selection of possible electrode geometries, which may in turn result in restrictions in the free movement of the electrodes or of the micro-mirror. In addition, the mechanical suspensions along the torsion axis are frequently manufactured from polysilicon structures or oxide layer structures, whereby heat arising on the mirror surface due to incident radiation may be dissipated poorly into the substrate.

There is a demand for micro-mirrors, in particular capacitively operable micro-mirrors, which are simple and cost-effective to manufacture, whose mechanical robustness is improved, whose geometrical dimensions may be flexible to implement in the manufacturing process, and which have an improved heat conduction characteristic.

### SUMMARY OF THE INVENTION

According to one aspect, the present invention provides a micro-electromechanical reflector including an electrode substrate having a first surface and a second surface, which is opposite to the first surface, on whose first surface a monocrystalline silicon layer is situated, a plurality of electrode recesses, which are introduced from the second surface into the electrode substrate, at least one torsion spring structure, which is implemented in the monocrystalline silicon layer above one of the electrode recesses, a carrier substrate, which is applied to the second surface of the electrode substrate, and a reflector surface, which is situated on the monocrystalline silicon layer. At least one first electrode, which is movably mounted in the electrode substrate via the torsion spring structure, and at least one second electrode, which is mechanically fixedly anchored to the carrier substrate and the monocrystalline silicon layer, are produced by the electrode recesses. Furthermore, the electrode surfaces of the first electrode and the second electrode are situated in parallel to one another and perpendicularly to the surfaces of the electrode substrate.

According to another aspect, the present invention provides a method for manufacturing a micro-electromechanical reflector, having the steps of implementing electrically conductive vias through an oxide layer implemented on an electrode substrate and a monocrystalline silicon layer implemented on the oxide layer, implementing at least one torsion spring structure in the monocrystalline silicon layer, implementing electrode recesses in a surface of the electrode substrate facing away from the monocrystalline layer, so that at least one first electrode, which is movably mounted in the electrode substrate via the torsion spring structure, and at least one second electrode, which is mechanically fixedly anchored to the monocrystalline silicon layer, are produced by the electrode recesses, the electrode surfaces of the first electrode and the second electrode being situated in parallel to one another and perpendicularly to the surfaces of the electrode substrate, applying a carrier substrate to the surface of the electrode substrate facing away from the monocrystalline layer, and applying a reflector surface above the monocrystalline silicon layer.

It is one aspect of the present invention to provide a capacitively activatable micro-mirror device or reflector device based on a MEMS, in which vertical electrode surfaces are etched out of the electrode substrate and are mechanically anchored on the mirror-side surface of the substrate over monocrystalline silicon layers. The surface opposite the mirror-side surface is provided with a conduction substrate, via which voltage may be applied to the electrodes. Stationary electrodes, on the one hand, and electrodes movable with respect to the stationary electrodes, on the other hand, are etched out of the electrode substrate, the movable electrodes having a mechanical coupling to a carrier structure having a reflective surface and an electrostatic force between the electrodes resulting in tilting of the movable electrodes and the carrier structure around a torsion axis lying in the substrate plane.

A substantial advantage of this micro-mirror device is that the electrodes are suspended very robustly via the monocrystalline layer in the substrate. This increases the precision with which the micro-mirror may be actuated. In addition, the thermal conductivity of the monocrystalline layer is substantially higher than that of polysilicon layers or oxide layers, for example, so that radiant heat arising on the mirror surface may be dissipated substantially more efficiently into the electrode substrate or the conduction substrate.

Such micro-mirror devices may be configured having correspondingly smaller dimensions in the spacing of the electrodes from one another, so that the effective active capacitive electrode surface is increased. A smaller space requirement and a more cost-effective construction thus advantageously result.

According to one specific embodiment of the reflector according to the present invention, the reflector may furthermore have an oxide layer, which is implemented between the monocrystalline layer and the electrode substrate, and at least one electrically conductive via through the monocrystalline layer and the oxide layer, via which the first electrode is electrically conductively connected to the monocrystalline layer. This allows the electrical connection of the movable first electrode via the monocrystalline layer to the carrier substrate, without the isolation of the first electrode from the second electrode being compromised.

According to another specific embodiment of the reflector according to the present invention, the carrier substrate may be connected to the electrode substrate via a metallic bonding material. This allows an electrically conductive connection, which is particularly mechanically stable, between the carrier substrate and the electrode substrate.

According to another specific embodiment of the reflector according to the present invention, silicon vias may be implemented through the carrier substrate up to the metallic bonding material from the surface of the carrier substrate facing away from the electrode substrate. The carrier substrate itself may thus advantageously be used as a conductive connection to a rewiring level, which is implementable on the bottom side of the carrier substrate.

According to another specific embodiment of the reflector according to the present invention, the carrier substrate may have, on the surface facing toward the electrode substrate, an oxide layer which extends laterally beyond the extension of the silicon vias on the carrier substrate in the area of the silicon vias. This substantially increases the mechanical stability of the stationary second electrodes.

According to another specific embodiment of the reflector according to the present invention, the first electrode may have a cylindrical shape. In one refinement, this allows four second electrodes, which are situated symmetrically around the cylindrical first electrode. Particularly large and robust electrically conductive connection surfaces between the stationary second electrodes may thus be provided under square or rectangular reflector surfaces.

According to another specific embodiment of the reflector according to the present invention, the reflector may furthermore have at least one auxiliary electrode, which is implemented on the side of the second electrode facing away from the first electrode by the electrode recesses and is situated vertically spaced apart from the second electrode. The activation signal for the first electrode may thus be advantageously conducted via the auxiliary electrode, i.e., independently of the potential of the electrode substrate.

According to another specific embodiment of the reflector according to the present invention, a metallic bonding material, a spacer connected to the metallic bonding material, and a mirror element situated on the spacer may be applied to the monocrystalline layer, and the reflector surface being applied to the side of the mirror element facing away from the spacer. The reflector surface may thus advantageously be enlarged, without trade-offs having to be accepted in the free movement, i.e., tilting freedom of the reflector.

According to another specific embodiment of the reflector according to the present invention, the mirror element may have a lateral extension which extends beyond the torsion spring structure in the substrate plane of the electrode substrate.

According to another specific embodiment of the reflector according to the present invention, the carrier substrate and/or the electrode substrate may have SOI substrates. Using such substrates, the required oxide layers for the potential separation of the electrodes are already provided, so that the manufacturing method for the reflector advantageously becomes simpler, shorter, and more cost-effective.

Further features and advantages of specific embodiments of the present invention result from the following description with reference to the appended drawings.

The described embodiments and refinements may be arbitrarily combined with one another, if reasonable. Further possible embodiments, refinements, and implementations of the present invention also include combinations, which are not explicitly mentioned, of features of the present invention described beforehand or hereafter with respect to the exemplary embodiments.

The appended drawings are to provide further understanding of the specific embodiments of the present invention. They illustrate specific embodiments and are used in conjunction with the description to explain principles and concepts of the present invention. Other specific embodiments and many of the mentioned advantages result in consideration of the drawings. The elements of the drawings are not necessarily shown true to scale to one another. Direction specifications such as “left”, “right”, “top”, “bottom”, “above”, “below”, “adjacent to”, “in front of”, “behind”, “vertical”, “horizontal”, or the like are only used for explanatory purposes in the following description and do not represent a restriction of the generality.

### BRIEF DESCRIPTION OF THE DRAWINGS

FIG. 1 shows a schematic view of a first intermediate product in the manufacture of a micro-electromechanical reflector according to the present invention in a cross-sectional view.

FIG. 2 shows a schematic view of a second intermediate product in the manufacture of a micro-electromechanical reflector according to the present invention in a cross-sectional view.

FIG. 3 shows a schematic view of a third intermediate product in the manufacture of a micro-electromechanical reflector according to the present invention in a cross-sectional view.

FIG. 4 shows a schematic view of a fourth intermediate product in the manufacture of a micro-electromechanical reflector according to the present invention in a cross-sectional view.

FIG. 5 shows a schematic view of a fifth intermediate product in the manufacture of a micro-electromechanical reflector according to the present invention in a cross-sectional view.

FIG. 6 shows a schematic view of a sixth intermediate product in the manufacture of a micro-electromechanical reflector according to the present invention in a cross-sectional view.

FIG. 7 shows a schematic view of a seventh intermediate product in the manufacture of a micro-electromechanical reflector according to the present invention in a cross-sectional view.

FIG. 8 shows a schematic view of a eighth intermediate product in the manufacture of a micro-electromechanical reflector according to the present invention in a cross-sectional view.

FIG. 9 shows a schematic view of a ninth intermediate product in the manufacture of a micro-electromechanical reflector according to the present invention in a cross-sectional view.

FIG. 10 shows a schematic view of a tenth intermediate product in the manufacture of a micro-electromechanical reflector according to the present invention in a cross-sectional view.

FIG. 11 shows a schematic view of an eleventh intermediate product in the manufacture of a micro-electromechanical reflector according to the present invention in a cross-sectional view.

FIG. 12 shows a schematic view of a twelfth intermediate product in the manufacture of a micro-electromechanical reflector according to the present invention in a cross-sectional view.

FIG. 13 shows a schematic view of a thirteenth intermediate product in the manufacture of a micro-electromechanical reflector according to the present invention in a cross-sectional view.

FIG. 14 shows a schematic view of a fourteenth intermediate product in the manufacture of a micro-electromechanical reflector according to the present invention in a cross-sectional view.

FIG. 15 shows a schematic view of a fifteenth intermediate product in the manufacture of a micro-electromechanical reflector according to the present invention in a cross-sectional view.

FIG. 16 shows a schematic view of a sixteenth intermediate product in the manufacture of a micro-electromechanical reflector according to the present invention in a cross-sectional view.

FIG. 17 shows a schematic view of a seventeenth intermediate product in the manufacture of a micro-electromechanical reflector according to the present invention in a cross-sectional view.

FIG. 18 shows a schematic view of an eighteenth intermediate product in the manufacture of a micro-electromechanical reflector according to the present invention in a cross-sectional view.

FIG. 19 shows a schematic view of a nineteenth intermediate product in the manufacture of a micro-electromechanical reflector according to the present invention in a cross-sectional view.

FIG. 20 shows a schematic view of a micro-electromechanical reflector according to the present invention in a cross-sectional view.

FIG. 21 shows a further schematic illustration of a micro-electromechanical reflector according to the present invention in a cross-sectional view.

FIG. 22 shows a schematic view of the micro-electromechanical reflector according to the present invention in FIG. 21 in a top view.

### DETAILED DESCRIPTION

FIG. 1 shows a schematic view of a first intermediate product in the manufacture of a micro-electromechanical reflector in a cross-sectional view. An electrode substrate 3 may be provided with an oxide layer 2, which is applied to a surface of electrode substrate 3. A monocrystalline silicon layer 1 may then be applied on oxide layer 2. In one embodiment variant, monocrystalline silicon layer 1 may be a first functional layer on a silicon on insulator wafer as electrode substrate 3 (“silicon on insulator”, SOI wafer).

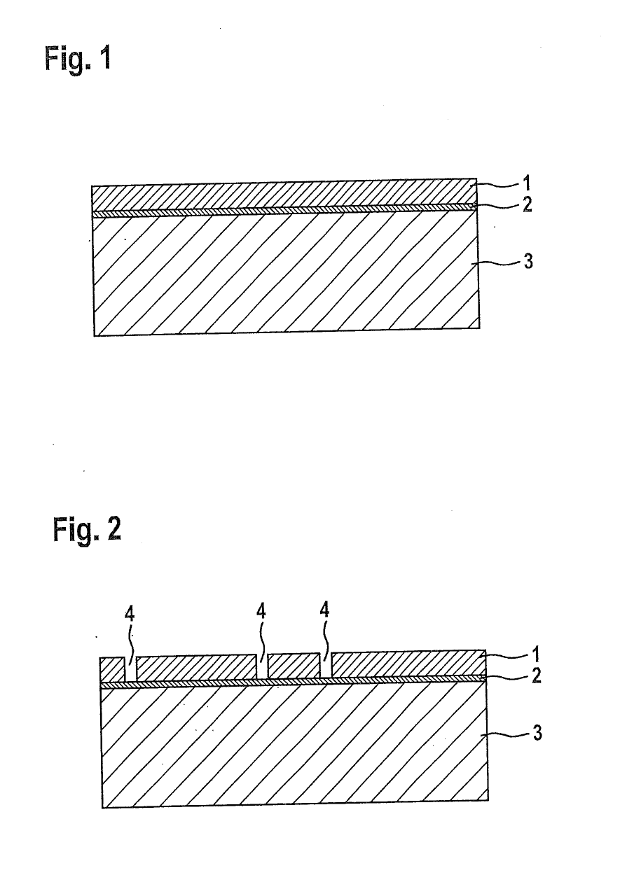

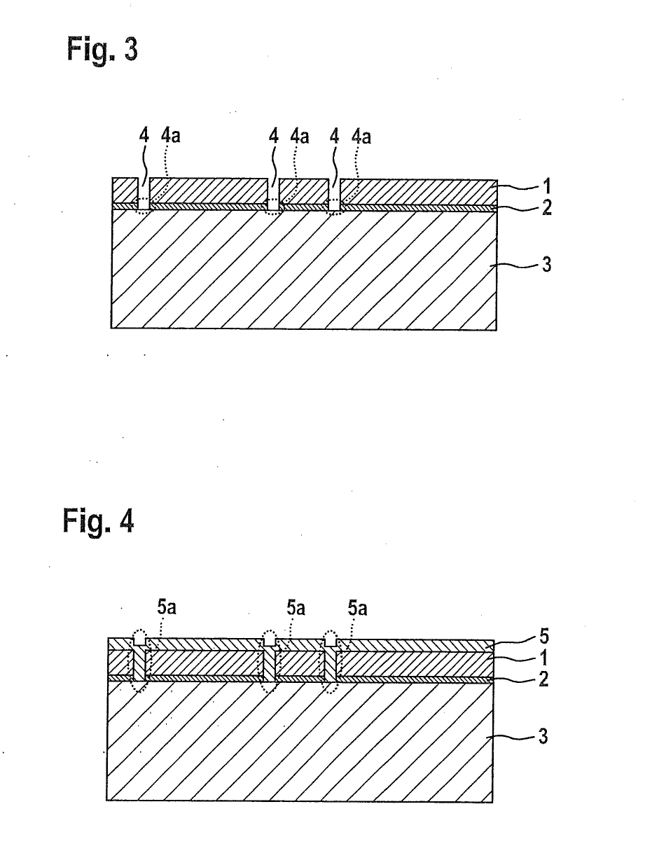

As shown in FIG. 2, vias (“vertical interconnect access”) or trenches 4, which extend down to oxide layer 2, may be introduced into monocrystalline silicon layer 1. As shown in FIG. 3, oxide layer 2 may also be etched down to electrode substrate 3 in the area of via bottom or trench bottom 4a.

FIG. 4 shows a schematic view of an intermediate product of a micro-electromechanical reflector. Manufactured vias or trenches 4 are filled using an electrically conductive material 5. If electrode substrate 3 and monocrystalline silicon layer 1 have different doping types, for example, n-doping and p-doping, material 5 may have a metal layer, for example, a layer made of titanium and titanium nitride. A barrier layer 5 may be deposited, on which a tungsten layer is deposited from the chemical gas phase. In contrast, in the case of an identical doping type of electrode substrate 3 and monocrystalline silicon layer 1, it is possible to carry out a deposition of a silicon layer 5 from the chemical gas phase. Silicon layer 5 may be doped during or after the deposition process. This may be carried out, for example, in that in a temperature step, the doping of electrode substrate 3 and monocrystalline silicon layer 1 is introduced into silicon layer 5.

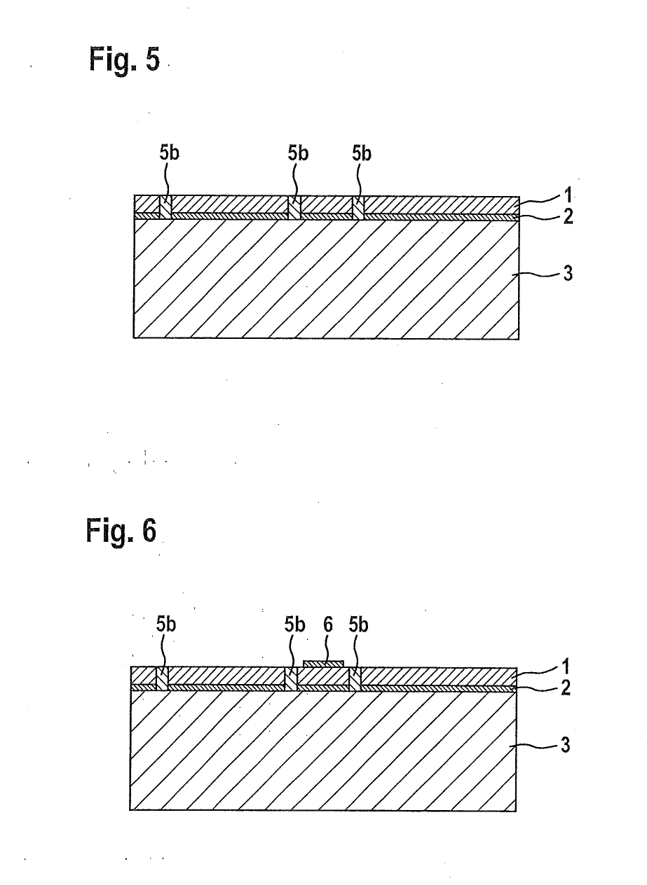

As is apparent in FIG. 5, filled vias 5a may be freed from excess material layer 5 in a planarization step, so that electrically conductive vias 5b are formed from electrode substrate 3 through oxide layer 2 and monocrystalline silicon layer 1.

FIG. 6 shows how the reflector surface may be prepared in the area between two vias 5b. A reflector surface, for example, a mirror metal, may be deposited directly on monocrystalline silicon layer 1. As shown in the example of FIG. 6, however, an aluminum layer 6 may also be constructed first in the area between two vias 5b on monocrystalline silicon layer 1. This aluminum layer 6 may then be used for the construction of a mirror element lying above monocrystalline silicon layer 1, as explained hereafter with reference to FIG. 8.

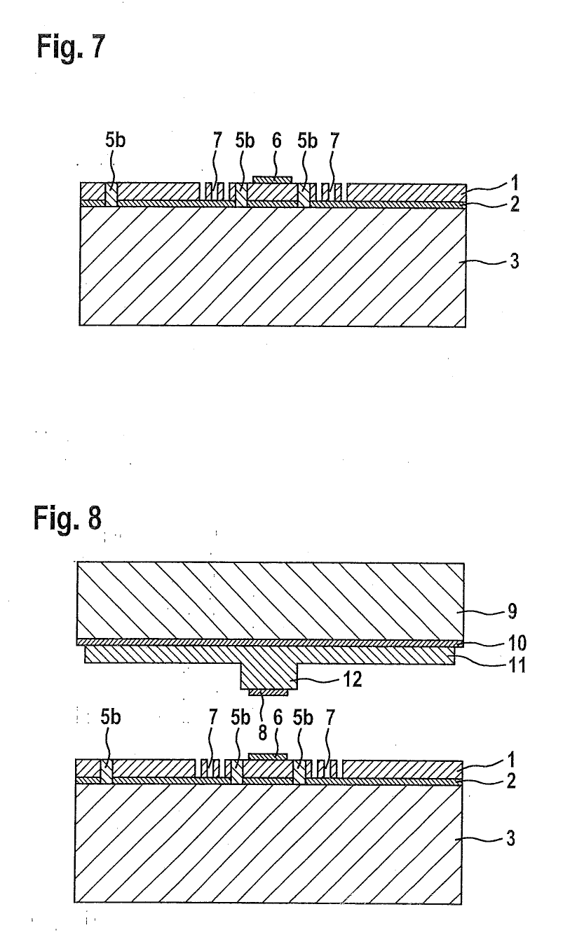

FIG. 7 shows the structuring of monocrystalline silicon layer 1. Torsion spring structures 7, which may have a cross-sectional ratio of width to height which deviates strongly from 1, for example, values of less than 0.5 or greater than 2, for example, are applied outside two vias 5b. Therefore, improved thermal conductivity characteristics may be achieved with equal torsional rigidity of torsion spring structures 7.

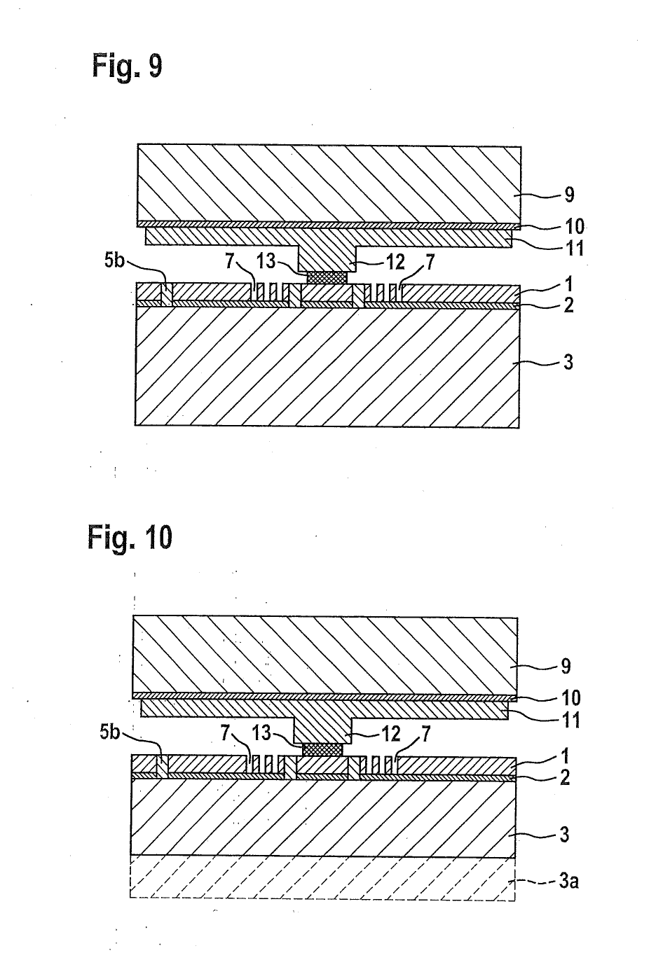

FIG. 8 shows the bonding of a carrier wafer 9 having an oxide layer 10 and a monocrystalline silicon layer 11 on electrode substrate 3. Carrier wafer 9 may be an SOI wafer, for example. A pedestal or spacer 12, whose surface is provided with a bonding material 8, may be provided on this wafer 9. For example, bonding material 8 may be a directly applied germanium layer on spacer 12. Spacer 12 may also be manufactured from silicon. Monocrystalline silicon layer 11 and spacer 12 may already be pre-structured, so that a release of the movable mirror structures or reflector surfaces may be carried out via a silicon etching process on the top side of carrier wafer 9 with subsequent isotropic oxide etching. As shown in FIG. 9, the bonding of bonding material 8 to bonding material 6 produces a solid bond between electrode substrate 3 and carrier wafer 9. In the case of an aluminum layer as bonding material 6 and a germanium layer as bonding material 8, silicon may diffuse into the aluminum-germanium bond and advantageously increase the melting temperature of the bond.

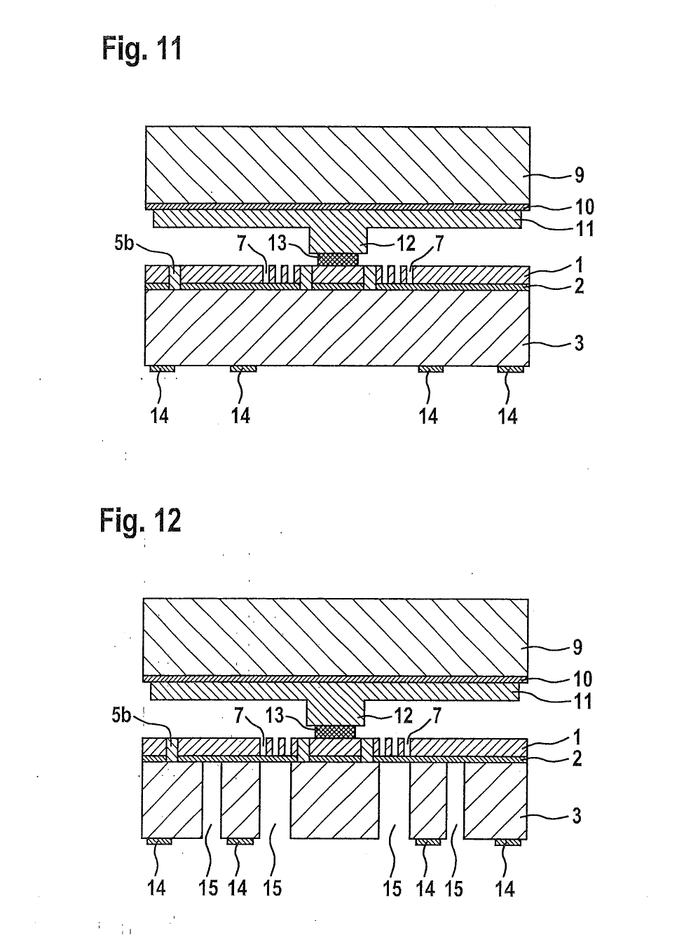

After the thinning of electrode substrate 3 from the bottom side in area 3a shown in FIG. 10, bonding surfaces 14 may be prepared on the rear side or bottom side of electrode substrate 3, for example, via a structured aluminum layer 14, as schematically indicated in FIG. 11.

FIG. 12 shows a schematic view of the etching process, using which electrode recesses 15 are introduced into electrode substrate 3. Electrode recesses 15 are etched in particular directly below torsion spring structures 7, to release the middle region between two torsion spring structures 7 from remaining electrode substrate 3. A first vertical electrode, which is movably mounted in electrode substrate 3 via torsion spring structure 7, thus results in electrode substrate 3. The first vertical electrode is electrically conductively connected at the surface via oxide layer 2 to monocrystalline silicon layer 1 on electrode substrate 3.

Further electrode recesses 15 may be produced in the edge area of electrode substrate 3 to separate second electrodes, which are mechanically fixedly anchored to monocrystalline silicon layer 1, from auxiliary electrodes, the auxiliary electrodes being implemented on the side of the second electrode facing away from the first electrode by electrode recesses 15 and being situated vertically spaced apart from the second electrode. In particular, the auxiliary electrodes may be situated below vias 5b, to conduct electrical potential via the auxiliary electrodes and vias 5b to the first electrode.

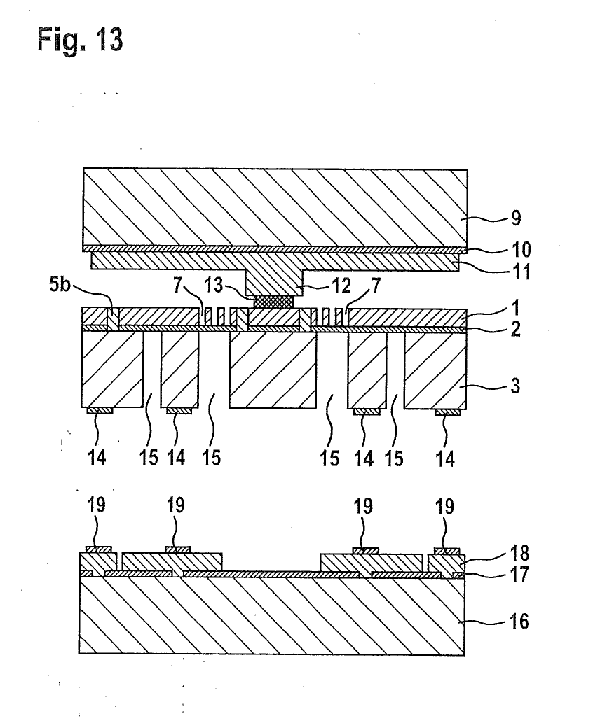

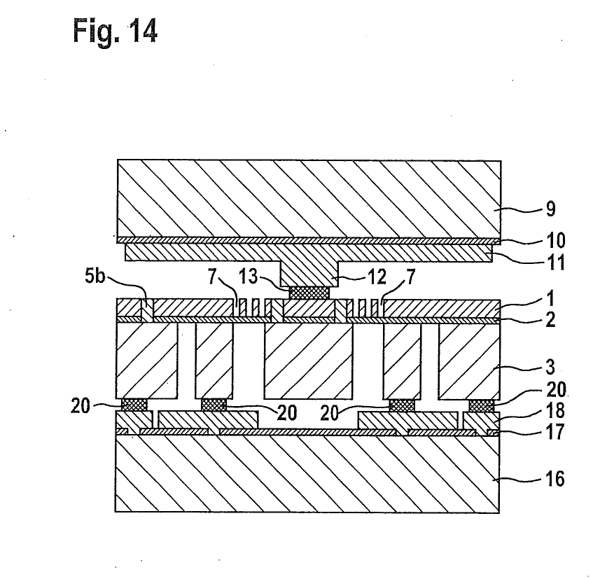

FIG. 13 shows the subsequent application of a carrier substrate 16 having an oxide layer 17 and a polysilicon layer 18 to the surface of electrode substrate 3 facing away from monocrystalline silicon layer 1. For example, an SOI wafer may also be used for carrier substrate 16. Electrode substrate 3 and carrier substrate 16 may also be connected via a bonding process, in that metallizations 19, for example, germanium layers 19, which are applied to polysilicon layer 18, are bonded to bonding surfaces 14, for example, aluminum layers 14. A metallic bonding method may be used for this purpose, which, for example, in the case of aluminum-germanium bonds 20—as shown in FIG. 14—results in diffusion of silicon from carrier substrate 16 into the bond and an increase of the melting temperature resulting therefrom. The bond thus advantageously does not melt a second time in further temperature steps.

In particular one of the vertical second electrodes is electrically and mechanically connected to carrier substrate 16 stably and immovably with respect to electrode substrate 3 by the bonding of bonds 20. Polysilicon layer 18 may be structured in such a way that adjacent second electrodes and auxiliary electrodes are electrically separated from one another, and the area below the movable first electrode is released from polysilicon layer 18. Optionally, oxide layer 17 may also be suitably structured to release the movable first electrode in electrode substrate 3 to ensure maximum mobility.

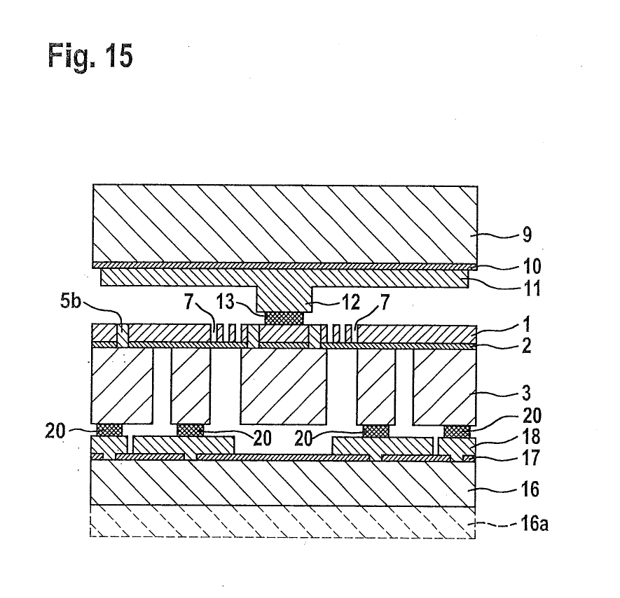

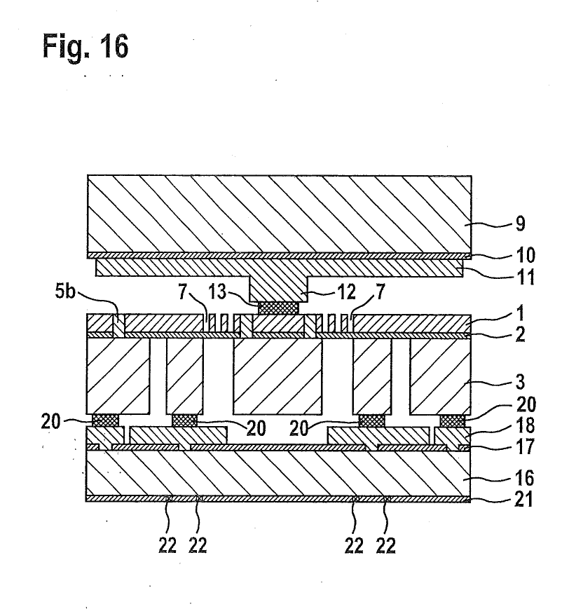

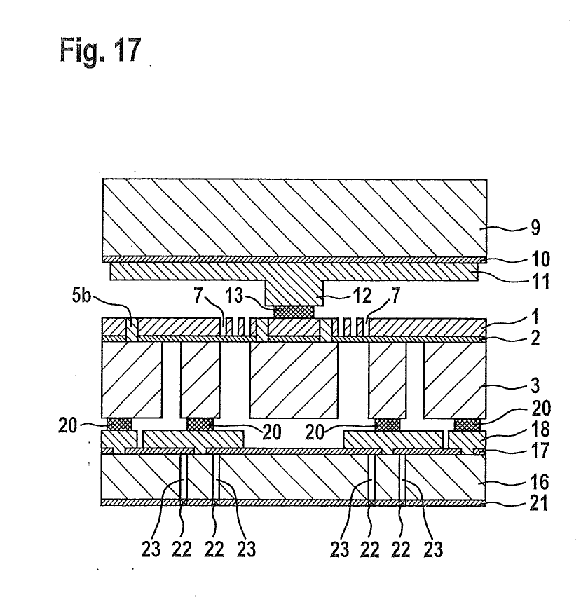

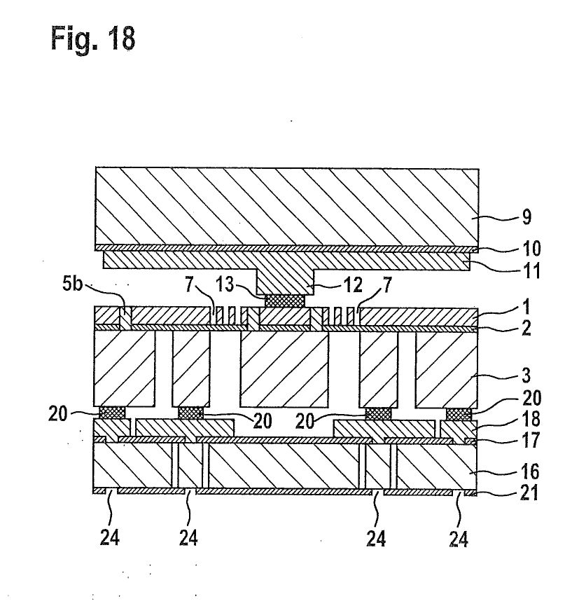

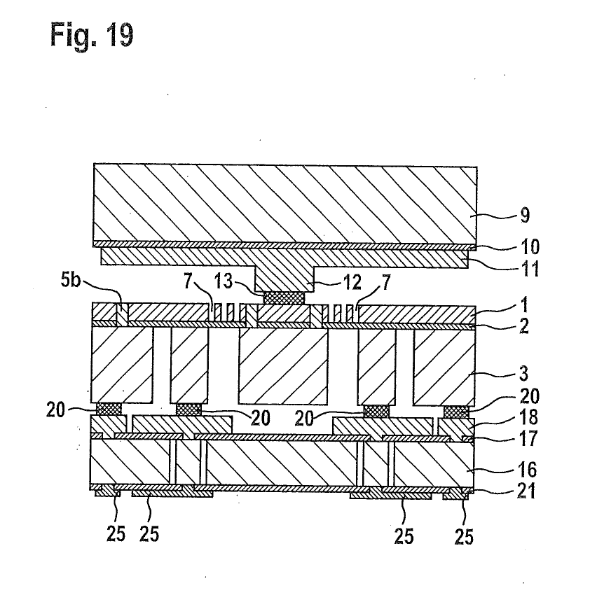

FIGS. 15 through 18 show the implementation of silicon vias 22, 23, 24 in carrier substrate 16, which may optionally be thinned beforehand. Electrical signals of the first and second electrodes may be conducted from silicon layer 18, which is situated on carrier substrate 16, through carrier substrate 16 to the bottom side of carrier substrate 16 via silicon vias 22, 23, and 24. Silicon vias 22, 23, and 24 may be produced in a further oxide layer 21 on the bottom side of carrier substrate 16, on which rewirings 25 may then be produced in a rewiring level, as shown in FIG. 19. The application of silicon vias may be carried out similarly as described in the publication DE 10 2009 045 385 A1. It is favorable if, in particular in the area of the stationary second electrodes, silicon layer 18 overlaps the area of silicon via 24 up into the carrier substrate areas of carrier substrate 16. The overlap may be selected as sufficiently large, at least at one point, so that oxide layer 17 also still overlaps carrier substrate 16 in this area. This ensures a high mechanical stability of the second electrodes. The overlap may also be formed sufficiently large around silicon via 24 so that the mirror-side surface of electrode substrate 3 is completely and hermetically separated from the bottom side area of carrier substrate 16, so that the activation electronic system on the bottom side of carrier substrate 16 remains protected as well as possible.

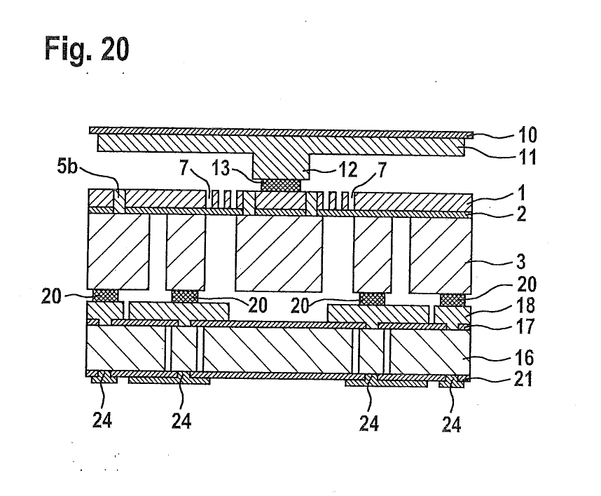

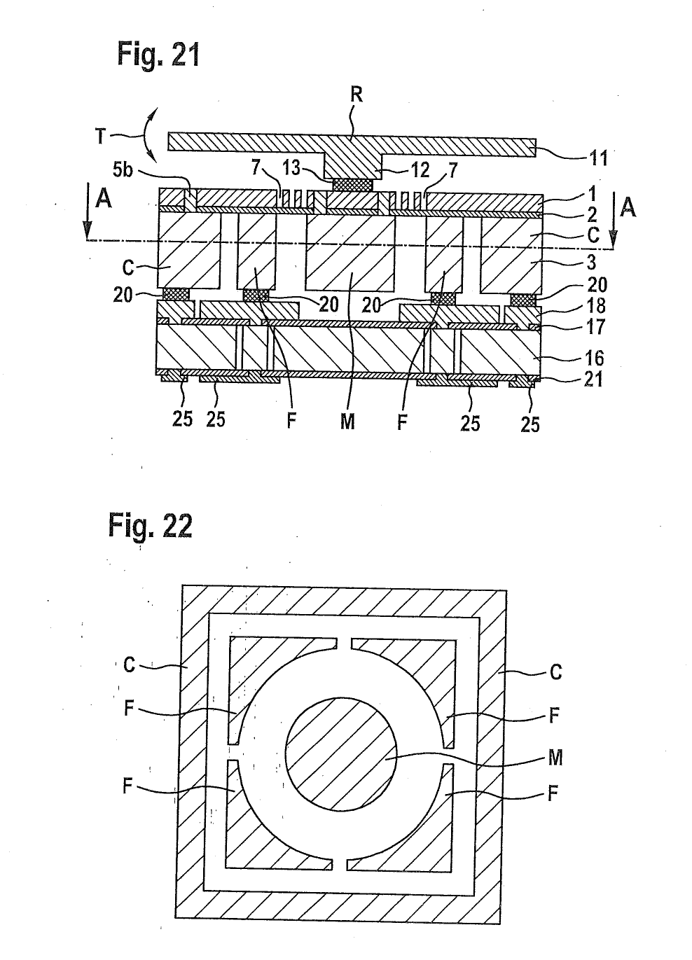

After the application of carrier substrate 16, the substrate stack is sufficiently mechanically stabilized to remove carrier wafer 9, for example, via an etching process, as shown in FIG. 20. Exposed oxide layer 10 may then be removed via a gas phase etching process using hydrofluoric acid to ensure the cleanest and smoothest mirror surface possible on mirror element 11—as shown in FIG. 21—on which a reflector surface R may then be applied.

FIG. 21 furthermore shows an example of movable first electrode M, stationary second electrodes F, and optionally provided auxiliary electrodes C in the outer area of electrode substrate 3. A torsion of electrode M around a torsion axis, which extends in parallel to the substrate plane of electrode substrate 3 and in monocrystalline silicon layer 1, may then be produced via the application of a voltage between first electrode M and one of second electrodes F, so that a corresponding torsion T of mirror element 11 or reflector surface R results. A great tilting freedom of mirror element 11 may be ensured by spacer 12. In addition, mirror element 11 may be configured in such a way that it protrudes beyond the area of the movable electrode, to create a large reflector surface.

FIG. 22 shows a schematic view of the reflector in FIG. 21 along section line A-A shown in FIG. 21. Movable electrode M may be cylindrical, for example, a hollow cylindrical element. It may be favorable to situate four stationary electrodes F around movable electrode M. In the case of rectangular or square mirror elements 11, stationary electrodes F may be implemented as rotated by 45° in relation to the alignment of mirror element 11 in a particularly space-saving way, so that particularly large connection surfaces are provided for stationary electrodes F between monocrystalline silicon layer 1 and stationary electrodes F below mirror element 11. The spacing between movable electrode M and stationary electrodes F may be selected in particular to be greater than the spacing between stationary electrodes F and auxiliary electrodes C.

Single reflectors and also reflector arrays may be manufactured using the described process sequence.

What is claimed is:

1. A micro-electromechanical reflector, comprising:
an electrode substrate having a first surface and a second surface opposite to the first surface, on whose first surface a monocrystalline silicon layer is situated;
a plurality of electrode recesses, which are introduced from the second surface into the electrode substrate;
at least one torsion spring structure, which is implemented in the monocrystalline silicon layer above one of the electrode recesses;
a carrier substrate, which is applied to the second surface of the electrode substrate; and
a reflector surface, which is situated on the monocrystalline silicon layer;
wherein at least one first electrode, which is movably mounted in the electrode substrate via the torsion spring structure, and at least one second electrode, which is mechanically fixedly anchored to the carrier substrate and the monocrystalline silicon layer, are formed by the electrode recesses, and the electrode surfaces of the first electrode and the second electrode are situated in parallel to one another and perpendicularly to the surfaces of the electrode substrate.

2. The micro-electromechanical reflector of claim 1, further comprising:
an oxide layer, which is implemented between the monocrystalline layer and the electrode substrate; and
at least one electrically conductive via through the monocrystalline layer and the oxide layer, via which the first electrode is electrically conductively connected to the monocrystalline layer.

3. The micro-electromechanical reflector of claim 1, wherein the carrier substrate is connected to the electrode substrate via a metallic bonding material.

4. The micro-electromechanical reflector of claim 3, wherein silicon vias are implemented through the carrier substrate up to the metallic bonding material from a surface of the carrier substrate facing away from the electrode substrate.

5. The micro-electromechanical reflector of claim 4, wherein the carrier substrate has, on the surface facing the electrode substrate, an oxide layer which extends laterally beyond the extension of the silicon vias on the carrier substrate in the area of the silicon vias.

6. The micro-electromechanical reflector of claim 1, wherein the first electrode has a cylindrical shape.

7. The micro-electromechanical reflector of claim 6, wherein four second electrodes are implemented, which are situated symmetrically around the cylindrical first electrode.

8. The micro-electromechanical reflector of claim 1, further comprising:
at least one auxiliary electrode, which is implemented by the electrode recesses on the side of the second electrode facing away from the first electrode and is situated vertically spaced apart from the second electrode.

9. The micro-electromechanical reflector of claim 1, wherein a metallic bonding material, a spacer connected to the metallic bonding material, and a mirror element situated on the spacer are applied to the monocrystalline layer, and the reflector surface is applied to the side of the mirror element facing away from the spacer.

10. The micro-electromechanical reflector of claim 9, wherein the mirror element has a lateral extension which extends beyond the torsion spring structure in the substrate plane of the electrode substrate.

11. The micro-electromechanical reflector of claim 1, wherein at least one of the carrier substrate and the electrode substrate has an SOI substrate.

12. A method for manufacturing a micro-electromechanical reflector, the method comprising:
implementing electrically conductive vias through an oxide layer, which is implemented on the electrode substrate, and a monocrystalline silicon layer, which is implemented on the oxide layer;
implementing at least one torsion spring structure in the monocrystalline silicon layer;
implementing electrode recesses in a surface of the electrode substrate facing away from the monocrystalline silicon layer, so that at least one first electrode, which is movably mounted in the electrode substrate via the torsion spring structure, and at least one second electrode, which is mechanically fixedly anchored to the monocrystalline silicon layer, are formed by the electrode recesses, the electrode surfaces of the first electrode and the second electrode being situated in parallel to one another and perpendicularly to the surfaces of the electrode substrate;
applying a carrier substrate to the surface of the electrode substrate facing away from the monocrystalline silicon layer; and
applying a reflector surface above the monocrystalline silicon layer.
